(19) United States
(12) Patent Application Publication
(10) Pub. No.: US 2026/0367704 A1
(43) Pub. Date: Nov. 19, 2026

(54) INFORMATION PROCESSING APPARATUS, INFORMATION PROCESSING METHOD, AND FRICTION VARIABLE DEVICE

(71) Applicant: SONY GROUP CORPORATION, TOKYO (JP)

(72) Inventors: MIYU IWAFUNE, TOKYO (JP); MASAO KONDO, TOKYO (JP); AKIRA ONO, TOKYO (JP); HIROTO KAWAGUCHI, TOKYO (JP)

(21) Appl. No.: 19/144,128

(22) PCT Filed: Dec. 22, 2023
(86) PCT No.: PCT/JP2023/046063

§ 371 Date: Jun. 27, 2025

(30) Foreign Application Priority Data
Jan. 5, 2023 (JP) 2023-000658

(51) Int. Cl. G06F 3/01; G02B 27/01

(52) U.S. Cl. CPC G06F 3/016; G02B 27/0101; G02B 27/0172; G06F 3/011; G02B 2027/0138

(57) ABSTRACT

An information processing apparatus according to the present disclosure includes an acquisition unit that acquires control information used to control a control target surface that is a surface to be controlled regarding friction, and a friction state determination unit that determines a friction state of the control target surface on the basis of the control information acquired by the acquisition unit.

### FIELD

The present disclosure relates to an information processing apparatus, an information processing method, and a friction variable device.

### BACKGROUND

Conventionally, a technique for changing a state of friction generated in an object is known. For example, there is provided a technique for increasing a change width of a friction coefficient by changing a contact area with a contact target object so as to reduce the contact area.

### CITATION LIST

### Patent Literature

Patent Literature 1: JP 2017-190537 A

### SUMMARY

### Technical Problem

However, the prior art is not necessarily capable of appropriately changing the friction state of the surface to be controlled. For example, in the prior art, a friction coefficient variable sheet body capable of changing a surface friction coefficient by forming periodic undulation in an in-plane compression direction is used, and a complicated structure having periodic undulation is required. Further, what kind of information is used to change the surface friction coefficient is not considered, and it may be difficult to appropriately change the surface friction coefficient. As described above, in a case where the friction state of the surface to be controlled is changed, there is room for improvement in terms of information processing for changing the friction state and a structure for changing the friction state, and it is desired to appropriately change the friction state of the surface to be controlled.

Therefore, the present disclosure proposes an information processing apparatus, an information processing method, and a friction variable device capable of appropriately changing a friction state of a surface to be controlled.

### Solution to Problem

According to the present disclosure, an information processing apparatus includes an acquisition unit that acquires control information used to control a control target surface that is a surface to be controlled regarding friction; and a friction state determination unit that determines a friction state of the control target surface on a basis of the control information acquired by the acquisition unit.

### BRIEF DESCRIPTION OF DRAWINGS

FIG. 1 is a view illustrating an example of friction control processing according to an embodiment of the present disclosure.

FIG. 2 is a view illustrating an application example of the friction variable device according to the embodiment of the present disclosure.

FIG. 3 is a view illustrating a configuration example of a friction control processing system according to an embodiment of the present disclosure.

FIG. 4 is a diagram illustrating a functional configuration example of the friction control processing system according to the embodiment of the present

FIG. 5 is a flowchart illustrating a procedure of information processing according to the embodiment of the present disclosure.

FIG. 6 is a flowchart illustrating a procedure of friction control processing of the friction control processing system.

FIG. 7 is a side view illustrating a support member of the friction variable device.

FIG. 8 is a side view illustrating a support member of the friction variable device.

FIG. 9 is a view illustrating a configuration example of a friction control processing system according to a first modification of the present disclosure.

FIG. 10 is a diagram illustrating a functional configuration example of the friction control processing system according to the first modification of the present disclosure.

FIG. 11 is a view illustrating a configuration example of a friction control processing system according to a second modification of the present disclosure.

FIG. 12 is a diagram illustrating a functional configuration example of the friction control processing system according to the second modification of the present disclosure.

FIG. 13 is a hardware configuration diagram illustrating an example of an information processing apparatus and a computer that implements functions of the information processing apparatus.

### DESCRIPTION OF EMBODIMENTS

Hereinafter, an embodiment of the present disclosure will be described in detail with reference to the drawings. Note that an information processing apparatus, an information processing method, and a friction variable device according to the present application are not limited by the embodiment. Further, in each of the following embodiments, the same parts are denoted by the same reference numerals, and redundant description will be omitted.

The present disclosure will be described according to the following order of items.
1. Embodiment
1-1. Outline and application example of friction control processing according to embodiment of present disclosure
1-1-1. Background, effects, other examples, and the like
1-2. Configuration of friction control processing system according to embodiment
1-3. Procedure of information processing according to embodiment
1-4. Configuration example of support member of friction variable device
1-5. Other application examples
2. Other embodiments
2-1. Other configuration examples
2-1-1. First modification
2-1-2. Second modification
2-2. Others
3. Effects according to present disclosure
4. Hardware configuration

### 1. Embodiment

### 1-1. Outline and Application Example of Friction Control Processing According to Embodiment of Present Disclosure

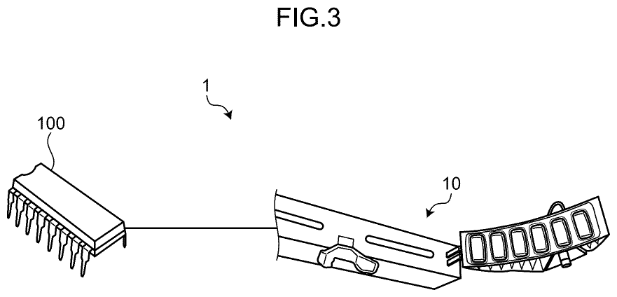

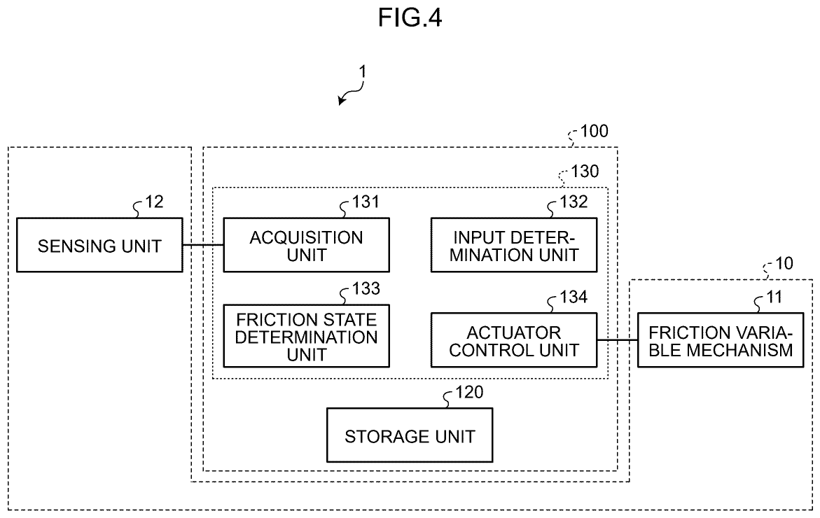

Friction control processing according to the embodiment of the present disclosure is implemented by a friction control processing system 1 as illustrated in FIGS. 3 and 4. Note that details of the friction control processing system 1 will be described with reference to FIGS. 3 and 4.

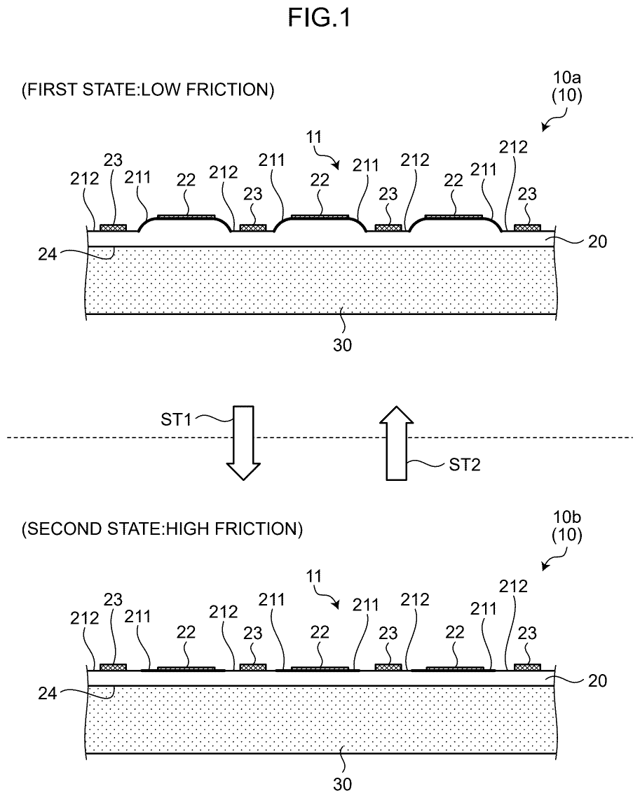

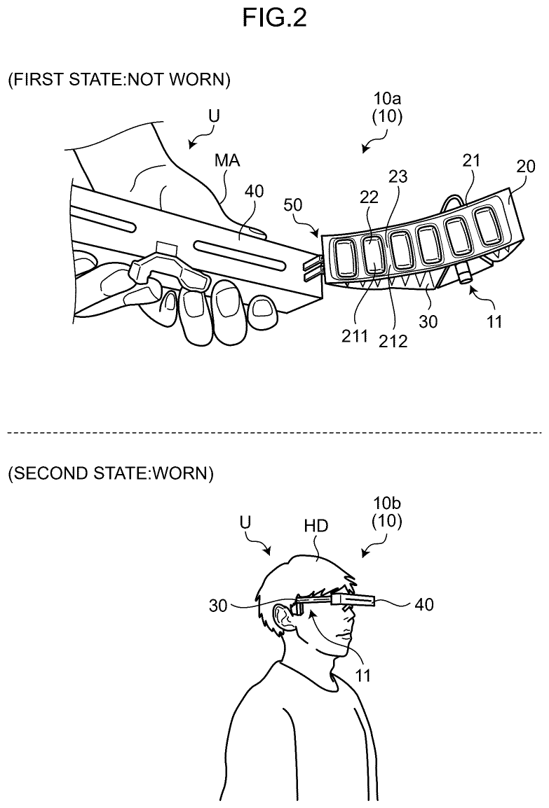

Hereinafter, an outline of the friction control processing will be first described with reference to FIG. 1, and then an application example of changing the friction state by the friction control processing will be described with reference to FIG. 2. FIG. 1 is a view illustrating an example of friction control processing according to the embodiment of the present disclosure. FIG. 2 is a view illustrating an application example of the friction variable device according to the embodiment of the present disclosure.

Hereinafter, a friction variable device 10 before a change in shape of a control target surface 21, that is, before a change in friction state will be described as a friction variable device 10a, and the friction variable device 10 after the change in shape of the control target surface 21, that is, after the change in friction state will be described as a friction variable device 10b. Note that the friction variable device 10 will be referred to as a friction variable device 10 in a case where the state of the friction variable device is not particularly distinguished.

In FIG. 1, the friction variable device 10a in a state in which a part (variable region and the like to be described later) of the control target surface 21 is expanded and the part protrudes (advances) will be described as the friction variable device 10 before a change in shape of the control target surface 21. That is, in FIG. 1, the friction variable device 10b in a state in which expansion of a part of the control target surface 21 is released, the part is retracted and becomes substantially flush with the other part will be described as the friction variable device 10 after a change in shape of the control target surface 21.

Note that the above definition is merely an example, and a state in which a part of the control target surface 21 is expanded may be referred to as a state after a change in shape of the control target surface 21, and a state in which expansion of a part of the control target surface 21 is released, the part is retracted and becomes substantially flush with the other part may be referred to as a state before a change in shape of the control target surface 21.

In addition, a change mode of the shape of the control target surface 21 is not limited to a mode in which a part (variable region and the like to be described later) of the control target surface 21 protrudes, and may be a mode in which a part of the control target surface 21 is recessed. In this case, a part of the control target surface 21 is recessed, and a state in which the part is recessed (contracted) may be set as a state after a change in shape of the control target surface 21, and a state in which the recess of the part of the control target surface 21 is released, and the part is advanced and becomes substantially flush with the other part may be set as a state before a change in shape of the control target surface 21. In addition, a state in which a part of the control target surface 21 is recessed may be a state before the shape of the control target surface 21 is changed, and a state in which the recess of a part of the control target surface 21 is released, a part of the control target surface is advanced, and the control target surface is substantially flush with the other part may be a state after the shape of the control target surface 21 is changed. As described above, as the definition of the state before and after the change in shape of the control target surface 21, any definition can be adopted depending on the change in shape of the control target surface 21, which member is provided in each portion, and the like.

Hereinafter, an outline of the friction control processing illustrated in FIG. 1 will be described. The friction variable device 10a and the friction variable device 10b in FIG. 1 illustrates a schematic view of the friction variable device 10 in a side view of a portion related to a friction variable mechanism 11 of the friction variable device 10. The friction variable device 10a indicates the friction variable device 10 in a first state that is a state before a change of the friction state (initial state).

Further, the friction variable device 10b indicates the friction variable device 10 in a second state that is a state after the change of the friction state.

For example, the friction variable device 10 in the second state corresponds to a state in which the shape of the control target surface 21 is changed the most from the friction variable device 10 in the first state, and indicates a state in which there is a large difference in shape from the friction variable device 10 in the first state. For example, the friction variable device 10 may be changeable to any state between the first state and the second state.

First, a configuration of the friction variable device 10 will be described. The friction variable device 10 includes the friction variable mechanism 11 including a sheet member 20 and a support member 30.

As the sheet member 20, a bendable member capable of changing the shape on the control target surface 21 side is used. For example, the sheet member 20 is formed by attaching a stretchable expansion film on a non-stretchable and bendable film. For example, the sheet member 20 is a sheet-like member that is variable in a direction intersecting the control target surface 21. Note that any material can be adopted as the sheet member 20 as long as a desired shape can be changed. The sheet member 20 has the control target surface 21 that is a surface with which a contact target object contacts in the friction variable device 10.

The control target surface 21 is a surface whose shape can be changed. The control target surface 21 is provided with a first region 211 and a second region 212. In FIG. 1, in the control target surface 21, the first region 211 and the second region 212 are alternately provided in a direction along the control target surface 21. The first region 211 is a variable region capable of advancing and retracting in a direction intersecting the control target surface 21 under the control of the friction variable mechanism 11. Note that a case where the first region 211 is a variable region is an example, and the second region 212 may be a variable region. For example, in the case of a protrusion mechanism by expansion using fluid, a space into which the fluid can flow is provided at least at a position corresponding to the first region 211 in the sheet member 20. In the case of the protrusion mechanism by expansion using fluid, the expansion and contraction of the first region 211 are controlled by adjusting the amount of fluid (input flow rate) inside the sheet member 20. Note that the configuration for changing the shape of the control target surface 21 is not limited to the configuration using the fluid and any configuration can be adopted, and this point will be described later.

A first member 22 having a first friction coefficient that is any friction coefficient is provided in the first region 211 of the control target surface 21, and a second member 23 having a second friction coefficient that is a friction coefficient higher than the first friction coefficient is provided in the second region 212 of the control target surface 21. For example, the first member 22 is attached to the first region 211, and the second member 23 is attached to the second region 212, thereby providing the first member 22 and the second member 23 on the control target surface 21.

The first member 22 is constituted by a low friction material. For example, a foamed sheet such as urethane or acrylic may be used as the first member 22. In addition, the second member 23 is constituted by a high friction material. For example, an adhesive sheet such as urethane or acrylic may be used as the second member 23. As described above, in FIG. 1, the first regions 211, which are variable regions capable of advancing and retracting by expansion or contraction, are arranged at regular intervals, and the first member 22, which is a material having low friction with the skin, is attached to the first regions 211. Further, between the first region 211 and the first region 211, the second region 212 that functions as a non-expansion portion that does not expand, contract, and the like is provided, and the second member 23 that is a material having high friction with the skin is attached to the second region 212.

Note that the configuration of the first member 22 and the second member 23 described above is merely an example, and any configuration can be adopted as long as the first member 22 and the second member 23 satisfy a desired relationship regarding friction. For example, if the second friction coefficient of the first member 22 and the second member 23 is higher than the first friction coefficient, the first member 22 and the second member 23 may be provided on the control target surface 21 by applying a material, or the first region 211 itself may be constituted by a low friction material and the second region 212 itself may be constituted by a high friction material.

The support member 30 has a function of supporting the sheet member 20 having the control target surface 21. The support member 30 is provided on a back surface 24 side, which is the opposite surface of the control target surface 21 from the control target surface 21, and supports the control target surface 21. As the support member 30, a member having a structure that deforms along a contact surface of a contact target object is used. As described above, the support member 30 deforms along the contact surface of the contact target object, so that the control target surface 21 can be deformed along the contact surface of the contact target object, and this point will be described later in detail.

The friction variable device 10 has a control mechanism for controlling a change in the shape of the control target surface 21. Note that the control mechanism may be included in the friction variable mechanism 11 or may be provided separately from the friction variable mechanism 11. The control mechanism is a mechanism that causes a variable region (such as the first region 211) of the control target surface 21 to advance or retract in a direction intersecting the control target surface 21. The control mechanism has a function of deforming the shape of the control target surface 21.

The control mechanism adjusts advancing and retracting of the variable region of the control target surface 21. The control mechanism has a function of advancing and retracting the variable region of the control target surface 21. For example, a drive mechanism deforms the shape of the control target surface 21 by advancing and retracting the variable region of the control target surface 21. For example, in a case where fluid is used for advancing and retracting the variable region of the control target surface 21, the control mechanism may be a flow rate adjustment mechanism including an adjustment valve, a pump, and the like for adjusting the amount of the fluid in the sheet member 20. For example, as the control mechanism, a drive mechanism including an actuator, a motor, or the like may be used according to the configuration of advancing and retracting the variable region of the control target surface 21. Note that the above is merely an example, and any configuration can be adopted as the control mechanism as long as the shape of the control target surface 21 can be changed to a desired shape.

As described above, the control mechanism changes the shape of the variable region of the control target surface 21. For example, the control mechanism is driven in accordance with an instruction from an information processing apparatus 100 (see FIG. 4) to change the shape of the variable region of the control target surface 21, whereby the information processing apparatus 100 changes the friction state of the control target surface 21 of the friction variable device 10.

Hereinafter, the change of the friction state between the friction variable device 10a and the friction variable device 10b will be described.

As illustrated in FIG. 1, the friction variable device 10a in the first state is in a state where the first region 211 in which the low-friction first member 22 is provided protrudes, and in a case where the contact target object comes into contact with the control target surface 21, a large area of the low-friction first member 22 comes into contact with the contact target object. Thus, the friction variable device 10a in the first state has lower friction with respect to the contact target object as compared with the friction variable device 10b in the second state.

As illustrated in FIG. 1, the friction variable device 10b in the second state is in a state where the first region 211 in which the low-friction first member 22 is provided does not protrude, and in a case where the contact target object comes into contact with the control target surface 21, a large area of the high-friction second member 23 comes into contact with the contact target object. Thus, the friction variable device 10b in the second state has higher friction with respect to the contact target object as compared with the friction variable device 10a in the first state.

For example, the information processing apparatus 100 determines to set the friction variable device 10 to the high friction state in a case where the status of the friction variable device 10 satisfies a condition for setting the high friction state. In this case, the information processing apparatus 100 instructs the friction variable device 10 so that the state of the friction variable device 10 becomes the friction variable device 10b in the second state.

Then, in a case where the friction variable device 10 is the friction variable device 10a in the first state, the friction variable device 10 changes the state to the friction variable device 10b in the second state (corresponding to the state transition ST1 in FIG. 1). For example, the control mechanism of the friction variable device 10 controls the friction variable mechanism 11 to be in the second state, thereby causing the state of the friction variable device 10 to transition from the friction variable device 10a in the first state to the friction variable device 10b in the second state. Note that, in a case where the friction variable device 10 is the friction variable device 10b in the second state, the state is maintained.

For example, the information processing apparatus 100 determines to set the friction variable device 10 to the low friction state in a case where the status of the friction variable device 10 satisfies a condition for setting the low friction state. In this case, the information processing apparatus 100 instructs the friction variable device 10 so that the state of the friction variable device 10 becomes the friction variable device 10a in the first state.

Then, in a case where the friction variable device 10 is the friction variable device 10b in the second state, the friction variable device 10 changes the state to the friction variable device 10a in the first state (corresponding to the state transition ST2 in FIG. 1). For example, the control mechanism of the friction variable device 10 controls the friction variable mechanism 11 to be in the first state, thereby causing the state of the friction variable device 10 to transition from the friction variable device 10b in the second state to the friction variable device 10a in the first state. Note that, in a case where the friction variable device 10 is the friction variable device 10a in the first state, this state is maintained.

With the above-described processing, the information processing apparatus 100 can appropriately change the friction state of the friction variable device 10 by changing the control target surface 21 of the friction variable device 10 according to the status of the friction variable device 10. In this manner, the information processing apparatus 100 can appropriately change the friction state of the surface to be controlled. That is, the friction variable device 10 can appropriately change the friction state by switching the state between the friction variable device 10a in the first state and the friction variable device 10b in the second state in accordance with an instruction from the information processing apparatus 100. As described above, the friction variable device 10 can appropriately change the friction state of the surface to be controlled.

Hereinafter, an application example of changing the friction state by the above-described friction control processing will be described with reference to FIG. 2. FIG. 2 is a view illustrating an application example of the friction variable device according to the embodiment of the present disclosure. Note that points similar to the contents described in FIG. 1 are denoted by the same reference numerals, and the description thereof will be omitted as appropriate. Further, in FIG. 2, reference numerals and the like unnecessary for description are appropriately omitted.

Note that, in FIG. 2, a case where the friction variable device 10 is a glasses-type wearable device will be described as an example, but the friction variable device 10 is not limited to an eyewear device such as a glasses-type wearable device and may be applied to any device, and this point will be described later. The friction variable device 10 illustrated in FIG. 2 includes a front unit 40 disposed in front of eyes of a user when worn, and a coupling unit 50 that couples the friction variable mechanism 11 and the front unit 40 and enables the friction variable mechanism 11 to move around a coupling portion.

In FIG. 2, the user U uses the friction variable device 10 that is a glasses-type wearable device. For example, the friction variable device 10 collects sensor information indicating a usage status of the friction variable device 10 by the user U, an environment in which the friction variable device 10 is used, and the like by sensing by a sensing unit 12 (see FIG. 4). Then, the friction variable device 10 transmits the collected sensor information to the information processing apparatus 100. The information processing apparatus 100 determines the status of the friction variable device 10 on the basis of the sensor information acquired from the friction variable device 10, and determines the state of the friction variable device 10 according to the status of the friction variable device 10.

In FIG. 2, the information processing apparatus 100 determines whether or not the status of the friction variable device 10 is worn (not worn) on the basis of the sensor information acquired from the friction variable device 10. The information processing apparatus 100 determines whether the status of the friction variable device 10 is worn or not worn on the basis of sensor information obtained by sensing of any sensor such as an image sensor or a pressure sensor.

The friction variable device 10a, which is the first state in FIG. 2, indicates a status in which the user U grips (holds) the friction variable device 10 with the finger MA, that is, a status in which the user U is not wearing the friction variable device 10. In this case, for example, the information processing apparatus 100 determines that the status of the friction variable device 10 is not worn on the basis of the sensor information, and instructs the friction variable device 10 to set the state of the friction variable device 10 to the first state.

As illustrated in FIG. 2, the friction variable device 10a in the first state is in a state where the first region 211 in which the low-friction first member 22 is provided protrudes, and in a case where the finger MA or the like of the user U comes into contact with the control target surface 21, a large area of the low-friction first member 22 comes into contact with the finger MA or the like. Therefore, regarding the friction variable device 10, as compared with the case of the friction variable device 10b in the second state, the friction variable device 10a in the first state is more easily held by the user U without being affected by the high friction material.

The friction variable device 10b, which is the second state in FIG. 2, illustrates a status in which the user U arranges the friction variable mechanism 11 on a side portion (cheek portion) of the head HD and arranges the front unit 40 in front of the eyes, that is, a status in which the user U is wearing the friction variable device 10 on the head HD. In this case, for example, the information processing apparatus 100 determines that the status of the friction variable device 10 is worn on the basis of the sensor information, and instructs the friction variable device 10 to set the state of the friction variable device 10 to the second state.

As illustrated in FIG. 2, the friction variable device 10b in the second state is in a state where the first region 211 in which the low-friction first member 22 is provided does not protrude, and in a case where the side portion (cheek portion) of the head HD of the user U comes into contact with the control target surface 21, a large area of the high-friction second member 23 comes into contact with the side portion (cheek portion) of the head HD of the user U. Thus, of the friction variable devices 10, the friction variable device 10b in the second state is more easily worn by the user U because it is firmly held on the head HD of the user U by the high friction material, as compared with the friction variable device 10a in the first state.

### 1-1-1. Background, Effects, Other Examples, and the Like

As described above, the information processing apparatus 100 can appropriately change the friction state of the surface to be controlled by determining the shape of the control target surface 21 of the friction variable device 10 according to whether the friction variable device 10 is worn or not worn on the basis of the sensor information. That is, the information processing apparatus 100 can appropriately change the friction state of the surface to be controlled by determining the friction state of the friction variable device 10 on the basis of the sensor information.

For example, in recent daily life, an access time and an intervening time with the cyberspace increase, and use of eyewear devices is becoming longer. Accordingly, there is an increasing demand for improvement in wearability of eyewear devices. Conventional eyewear devices are generally eyeglass-type devices that are fixed by a nose pad and a temple, or head mounted display (HMD) type devices that hold on and fix to the entire head with a band or the like. However, since an existing eyewear device is fixed by hooking or tightening the device on a face part, fatigue and pain are easily felt when used for a long time, and there is room for improvement in wearability. Further, it is also a problem that a tightening type eyewear device such as an HMD type device requires much labor to attach and detach.

On the other hand, in the friction control processing system 1, the friction of the adhesive surface between the friction variable device 10 and the skin (skin) of the user can be dynamically controlled, so that it is possible to implement wearing of the friction variable device 10 with less labor of attachment and detachment. Further, in the friction control processing system 1, by using the frictional force for fixing the friction variable device 10, the load applied to other portions such as the hook portion can be reduced or the tightening force can be reduced, so that it is possible to improve the wearability of the friction variable device 10 in long-term use.

For example, in the friction variable device 10, since the friction variable mechanism 11 is constituted by two or more materials having different friction coefficients, the friction of the contact surface can be controlled by controlling the contact amount of each material with the user's skin. As described above, the friction variable device 10 can have a flexible structure having a wide friction variable range and followability to the contact surface by using a plurality of materials. Further, the friction variable device 10 can arbitrarily set a friction variable range. Further, for example, the information processing apparatus 100 can appropriately control the friction between the friction variable device 10 and the skin of the user by controlling the friction of the contact surface between the friction variable device 10 and the skin of the user in accordance with the context such as the status of the friction variable device 10.

Note that the friction variable mechanism in the use case of the eyewear device is not limited to the aspect of the above-described embodiment, and may be any aspect. For example, in the friction variable device 10, the arrangement of the variable region (expansion portion) and the region (non-expansion portion) other than the variable region may be in any mode. For example, in the friction variable device 10, the expansion portion and the non-expansion portion may be arranged so that a high friction material exists at a central portion of the control target surface 21 and the high friction material expands so as to surround the periphery. In addition, the friction variable device 10 may create a plurality of flow paths and expand only an arbitrary position. The friction variable device 10 may be configured so that the high friction material is thicker than the low friction material when not expanded.

In addition, the friction control processing system 1 can implement desired interaction in the friction variable device 10 such as an eyewear device using the friction variable mechanism as described above. In the friction control processing system 1, when attached or detached, the friction variable device 10 has low friction to prevent the friction variable device from being caught by the skin. On the other hand, in the friction control processing system 1, the friction becomes high while the friction variable device 10 is worn, and can be brought into close contact with the skin of the user.

For example, the friction control processing system 1 senses whether or not the user holds the friction variable device 10 with a pressure sensor or the like disposed at any position such as a grip portion of the friction variable device 10. In this case, in a case where the pressure exceeds a threshold value, the information processing apparatus 100 determines (determines) that the user holds the friction variable device 10. In a case where the pressure is equal to or less than the threshold value, the information processing apparatus 100 determines (decides) that the user does not hold the friction variable device 10. Note that, as a sensing method for gripping the device, a capacitance sensor may be used, or sensing may be performed using an image acquired by an external camera.

For example, in a case of determining that the user holds the friction variable device 10, the friction control processing system 1 expands the expansion film using the air pump to increase the contact amount of the low friction material with respect to the skin. In a case where the friction control processing system 1 determines that the user does not hold the friction variable device 10, the friction control processing system 1 discharges air to increase the contact amount of the high friction material with respect to the skin.

Note that the friction control processing system 1 may change the contact amount of the friction variable device 10 with the skin of the user according to the skin quality, environment, use status, and the like of the individual. In addition, in order to visualize the change in friction, the friction control processing system 1 may change sound, light, or the like output from a device (apparatus) such as the friction variable device 10 according to the friction change. In addition, the friction control processing system 1 may visualize the change in friction using a material that changes in color or decoration when deformed.

For example, the friction control processing system 1 may perform control so that the friction changes only when a specific wearer performs individual identification by fingerprint authentication or the like.

For example, the friction control processing system 1 may change the friction state in accordance with a change in the wearing state of the friction variable device 10. For example, the friction control processing system 1 may change the state to a high friction state when the friction variable device 10 is put on, and change the state to a low friction state when the friction variable device is temporarily put on the forehead. The friction control processing system 1 may return (change) to a high friction state when the movement of the friction variable device 10 ends. The friction control processing system 1 may also perform such interaction according to the wearing state by grip detection in the same manner as at the time of attachment and detachment.

Note that the friction control processing system 1 may use not only an electrically controllable method using a pump but also a non-electrically controlled method as the control of the protrusion mechanism using the fluid described above. The friction control processing system 1 may perform a protruding operation by moving fluid accumulated in the portion to which a force is applied to the protrusion mechanism portion when the force is applied to widen the friction variable device 10.

For example, the friction control processing system 1 may use various mechanisms other than the mechanism using the fluid as the protrusion mechanism. For example, the friction control processing system 1 may use a vertical drive mechanism using a motor, or a vertical drive mechanism using traction by a wire or the like or expansion and contraction of an artificial muscle. In addition, for example, the friction control processing system 1 may use, as the protrusion mechanism, a mechanism having a structure of pushing out different kinds of materials embedded inside.

In addition, the friction control processing system 1 may use various mechanisms other than those using the protrusion mechanism as the friction variable mechanism. For example, the friction control processing system 1 may control the friction between the skin and the device by providing fine irregularities such as wrinkles on the surface (control target surface 21) of the friction variable device 10. For example, the friction control processing system 1 may control friction using suction of air. For example, the friction control processing system 1 may control friction by controlling a side pressure. For example, the friction control processing system 1 may control friction using a material whose friction coefficient changes by energization. For example, the friction control processing system 1 may control friction using van der Waals force imitating a structure of a gecko's hand.

With the above-described configuration, the friction control processing system 1 can dynamically change the friction of the contact surface between the device such as the friction variable device 10 and the skin. In addition, the friction control processing system 1 can implement a new wearing method that does not rely on tightening. For example, the friction control processing system 1 can implement a simple wearing method that saves labor of attaching and detaching the mask so as to attach and detach the mask. Further, for example, in a case where the friction variable device 10 is applied to a glasses-type eyewear device of temple type, the friction control processing system 1 can fix the friction variable device 10 by frictional force, and thus, it is possible to reduce the load on the nose pad and the ear.

### 1-2. Configuration of Friction Control Processing System According to Embodiment

The friction control processing system 1 illustrated in FIGS. 3 and 4 will be described. FIG. 3 is a view illustrating a configuration example of the friction control processing system according to the embodiment of the present disclosure. FIG. 4 is a diagram illustrating a functional configuration example of the friction control processing system according to the embodiment of the present disclosure.

First, a device configuration example of the friction control processing system 1 will be described with reference to FIG. 3. As illustrated in FIG. 3, the friction control processing system 1 includes the information processing apparatus 100 and the friction variable device 10. Note that the friction control processing system 1 may include a plurality of information processing apparatuses 100 and a plurality of friction variable devices 10.

The information processing apparatus 100 is a control device that controls the friction variable device 10. For example, the information processing apparatus 100 is connected to the friction variable device 10 by wired or near field communication or the like, and transmits and receives information to and from the friction variable device 10. The information processing apparatus 100 may have any arrangement mode as long as it can transmit and receive information to and from the friction variable device 10. For example, the information processing apparatus 100 may be integrated with the friction variable device 10. For example, the information processing apparatus 100 may be provided in the friction variable device 10. In FIG. 2, the information processing apparatus 100 may be provided on the front unit 40 of the friction variable device 10, or may be provided on the sheet member 20 or the support member 30.

The information processing apparatus 100 is a computer that determines a friction state of a control target surface on the basis of control information used to control the control target surface that is a surface to be controlled regarding friction. The information processing apparatus 100 is used to provide a service related to the change of the friction state of the friction variable device 10. The information processing apparatus 100 performs various types of information processing regarding a change in the friction state of the friction variable device 10.

In the friction control processing system 1, the information processing apparatus 100 acquires sensing information from the friction variable device 10. For example, in the friction control processing system 1, the information processing apparatus 100 is communicably connected to the friction variable device 10 by wired or near field communication.

The friction variable device 10 is a device capable of changing the frictional force of the control target surface. The friction variable device 10 includes at least the friction variable mechanism 11. The friction variable device 10 is a wearable device worn by the user. In FIG. 2, the friction variable device 10 is a glasses-type wearable device that can be attached and detached by the user. The friction variable device 10, which is a glasses-type wearable device, includes the friction variable mechanism 11, the front unit 40, and the coupling unit 50 that connects the friction variable mechanism 11 and the front unit 40.

Hereinafter, a functional configuration example of the friction control processing system 1 will be described with reference to FIG. 4.

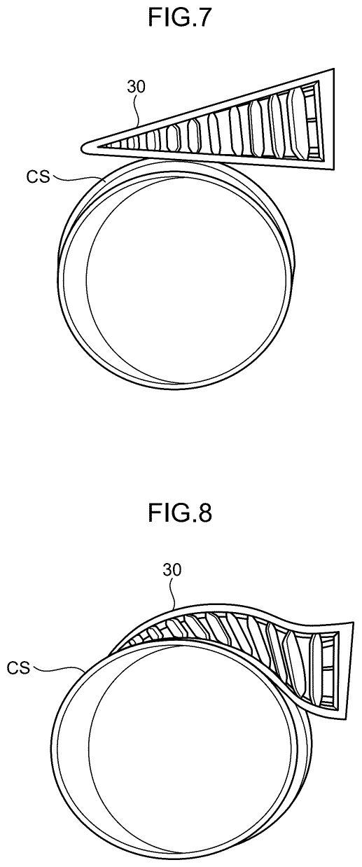

As illustrated in FIG. 4, the friction variable device 10 includes the friction variable mechanism 11 and the sensing unit 12. The friction variable mechanism 11 is a mechanism for changing the friction state of the control target surface 21 of the friction variable device 10. The friction variable mechanism 11 includes the sheet member 20, the first member 22 provided in the first region 211 of the control target surface 21, the second member 23 provided in the second region 212 of the control target surface 21, and the support member 30 provided on the back surface 24 side of the sheet member 20. Note that details of the configuration of 30 of the friction variable device 10 will be described with reference to FIGS. 7 and 8.

The sensing unit 12 detects various sensor information. For example, the sensing unit 12 includes an image sensor (camera) that captures an image. In this case, the image sensor of the sensing unit 12 images the periphery of the friction variable device 10. The image sensor of the sensing unit 12 captures an image used to estimate the status of the friction variable device 10. For example, the image sensor of the sensing unit 12 captures an image used to determine whether or not the user holds the friction variable device 10. For example, the image sensor of the sensing unit 12 captures an image used to determine whether or not the user wears the friction variable device 10.

Note that the sensing unit 12 is not limited to the image sensor, and may include various sensors. For example, the sensing unit 12 may include a pressure sensor that detects pressure. In this case, the pressure sensor of the sensing unit 12 is provided at a portion where the pressure fluctuates according to the status of the friction variable device 10. For example, the pressure sensor of the sensing unit 12 is provided at a portion (for example, a portion corresponding to a temple of eyeglasses) gripped by the user when the user grips the friction variable device 10. For example, the pressure sensor of the sensing unit 12 is provided in a portion (for example, a portion corresponding to the pad of the glasses) to which a load for holding the worn state by the user is applied when the user wears the friction variable device 10.

The sensing unit 12 transmits various sensor information detected by various sensors to the information processing apparatus 100. Note that the above is an example, and the sensing unit 12 is not limited to the above, and may include various sensors. For example, the sensing unit 12 may include an electrostatic sensor. For example, the sensing unit 12 may include a sensor that detects oil content or the like of the skin of the user. In addition, the sensing unit 12 may be a sensor that detects various biological signals such as a heart rate sensor that detects a heart rate of the user, an electroencephalogram sensor that detects an electroencephalogram of the user, a pulse sensor (pulse wave sensor) that detects a pulse of the user, a respiration sensor (exhalation sensor) that detects respiration of the user, and a perspiration sensor that detects perspiration of the user. In addition, the sensing unit 12 may be a sensor that detects various types of information such as temperature, humidity, illuminance, position, acceleration, light, pressure, gyro, and distance.

As illustrated in FIG. 4, the information processing apparatus 100 includes a storage unit 120 and a control unit 130. Note that the information processing apparatus 100 may include an input unit (for example, a keyboard, a mouse, or the like) that receives various operations from an administrator or the like of the information processing apparatus 100, and a display unit (for example, a liquid crystal display or the like) for displaying various types of information.

The storage unit 120 is implemented by, for example, a semiconductor memory element such as a random access memory (RAM) or a flash memory, or a storage device such as a hard disk or an optical disk. The storage unit 120 according to the embodiment stores various types of information used for friction control. The storage unit 120 stores various types of information regarding the sensor. The storage unit 120 stores sensed (sensed) sensing information (sensor information). The storage unit 120 stores various sensor information such as image information and pressure information indicating pressure.

Further, the storage unit 120 stores various types of information regarding a condition of friction change. The storage unit 120 stores various types of information regarding a condition used for determining whether or not to change the state of friction. The storage unit 120 stores a threshold value used for determining whether or not to change the state of friction, information indicating a specific condition such as when to change the state of friction, and the like.

Further, the storage unit 120 stores user information regarding a user who uses the friction variable device 10. The storage unit 120 stores user information including various types of information used to identify the user and various types of information regarding attributes of the user. Further, the storage unit 120 stores personal identification information used for personal identification (specification) of the user. For example, the storage unit 120 stores a face image of the user used to identify the user. For example, the storage unit 120 stores attribute information such as the age, gender, residence, place of employment, and interest of the user.

Note that the storage unit 120 is not limited to the above, and may store various types of information according to the purpose.

The control unit 130 is implemented by, for example, a central processing unit (CPU), a micro processing unit (MPU), or the like executing a program (for example, an information processing program such as a determination program according to the present disclosure) stored inside the information processing apparatus 100 with the RAM or the like being a work area. Further, the control unit 130 is a controller, and is implemented by, for example, an integrated circuit such as an application specific integrated circuit (ASIC) or a field programmable gate array (FPGA).

As illustrated in FIG. 4, the control unit 130 includes an acquisition unit 131, an input determination unit 132, a friction state determination unit 133, and an actuator control unit 134, and implements or executes functions and actions of information processing described below. Note that the internal configuration of the control unit 130 is not limited to the configuration illustrated in FIG. 4, and may be another configuration as long as information processing to be described later is performed. Furthermore, the connection relationship of the actuator control units included in the control unit 130 is not limited to the connection relationship illustrated in FIG. 4, and may be another connection relationship.

The acquisition unit 131 acquires various types of information. The acquisition unit 131 acquires various types of information from an external information processing apparatus. The acquisition unit 131 acquires various types of information from the friction variable device 10. The acquisition unit 131 acquires various types of information from another information processing apparatus such as the friction variable device 10. The acquisition unit 131 acquires various types of information from the storage unit 120.

The acquisition unit 131 acquires various types of information determined by the input determination unit 132. The acquisition unit 131 acquires various types of information determined by the friction state determination unit 133. The acquisition unit 131 acquires various types of information executed by the actuator control unit 134.

The acquisition unit 131 acquires control information used for controlling the control target surface 21 that is a surface to be controlled regarding friction.

The acquisition unit 131 acquires sensor information detected by the sensor as the control information.

The acquisition unit 131 acquires sensor information detected by the sensor. The acquisition unit 131 acquires sensor information including image information captured by the image sensor. The acquisition unit 131 acquires sensor information including image information in which the user is captured by the image sensor. For example, the acquisition unit 131 acquires image information captured by the image sensor from the friction variable device 10.

The acquisition unit 131 acquires sensor information including pressure information indicating the pressure to the friction variable device 10 detected by the pressure sensor. For example, the acquisition unit 131 acquires, from the friction variable device 10, information indicating the pressure to the friction variable device 10 detected by the pressure sensor provided in the friction variable device 10.

The acquisition unit 131 acquires not only sensor information but also any information as the control information. For example, the acquisition unit 131 acquires information (designation information) for designating the friction state by the user. In this case, the acquisition unit 131 receives an operation of designating the friction state by the user from the user. For example, the acquisition unit 131 receives, from the user, an operation of designating the friction state by the user for a predetermined operation function such as a switch. The acquisition unit 131 acquires designation information for the user to designate the friction state from the user.

The input determination unit 132 determines various types of information. The input determination unit 132 determines various types of information on the basis of the information from the external information processing apparatus or information stored in the storage unit 120. The input determination unit 132 determines various types of information from the storage unit 120. The input determination unit 132 specifies various types of information. The input determination unit 132 determines various types of information.

The input determination unit 132 determines the status of the friction variable device 10 capable of changing the friction state of the surface on the basis of the sensor information acquired by the acquisition unit 131. The input determination unit 132 determines whether or not the status of the friction variable device 10 having the control target surface 21 satisfies the condition regarding the change of the friction state.

The input determination unit 132 determines the status of the friction variable device 10 on the basis of the image information. The input determination unit 132 determines information regarding the user on the basis of the image information. The input determination unit 132 determines a contact mode of an object with respect to a plurality of regions of the friction variable device 10 on the basis of the image information.

The input determination unit 132 determines the status of the friction variable device 10 on the basis of the pressure information. The input determination unit 132 calculates the amount of change in pressure to the friction variable device 10.

The friction state determination unit 133 determines various types of information. The friction state determination unit 133 specifies various types of information. The friction state determination unit 133 determines various types of information. For example, the friction state determination unit 133 determines various types of information on the basis of the information from the external information processing apparatus or the information stored in the storage unit 120. The friction state determination unit 133 determines various types of information on the basis of information from another information processing apparatus such as the friction variable device 10.

The friction state determination unit 133 determines various types of information on the basis of the various types of information acquired by the acquisition unit 131. The friction state determination unit 133 determines various types of information on the basis of the various types of information determined by the input determination unit 132. The friction state determination unit 133 determines various types of information on the basis of the various types of information executed by the actuator control unit 134. The friction state determination unit 133 changes various types of information on the basis of the determination. The friction state determination unit 133 updates various types of information on the basis of the information acquired by the acquisition unit 131.

The friction state determination unit 133 determines whether or not to change the friction state of the surface (the control target surface 21 and the like) of the friction variable device 10 according to the status of the friction variable device 10 determined by the input determination unit 132. The friction state determination unit 133 determines whether or not to change the friction state of the surface of the friction variable device 10 on the basis of the amount of change in pressure. In a case where the amount of change in pressure is equal to or greater than the threshold value, the friction state determination unit 133 determines to change the friction state of the surface of the friction variable device 10.

In a case where a comparison result between the pressure detected by the sensing unit 12 and the threshold value satisfies the condition, the friction state determination unit 133 determines to change the friction state of the surface of the friction variable device 10. The friction state determination unit 133 determines the amount of change in the friction state of the surface of the friction variable device 10 according to the amount of change in pressure.

In a case where the context determined by the input determination unit 132 satisfies the condition, the friction state determination unit 133 determines to change the friction state of the surface of the friction variable device 10. The friction state determination unit 133 determines the amount of change in the friction state of the surface of the friction variable device 10 according to the context. The friction state determination unit 133 determines whether or not to change the friction state of the surface of the friction variable device 10 on the basis of the information regarding the user determined by the input determination unit 132.

The friction state determination unit 133 determines the friction state of the control target surface 21 on the basis of the control information acquired by the acquisition unit 131. The friction state determination unit 133 determines the friction state of the control target surface 21 on the basis of the sensor information. The friction state determination unit 133 determines whether or not to change the friction state of the control target surface 21 on the basis of the control information.

The friction state determination unit 133 determines whether or not to change the friction state of the control target surface 21 according to the status of the friction variable device 10 having the control target surface 21 based on the control information. The friction state determination unit 133 determines whether or not to change the friction state of the control target surface 21 according to the determination result by the input determination unit 132. The friction state determination unit 133 determines to change the friction state of the control target surface 21 in a case where the input determination unit 132 determines whether or not the status of the friction variable device 10 having the control target surface 21 satisfies the condition regarding the change of the friction state. The friction state determination unit 133 determines to change the friction state of the control target surface 21 in a case where the status of the friction variable device 10 having the control target surface 21 satisfies the condition regarding the change of the friction state.

The friction state determination unit 133 determines a change amount regarding friction of the control target surface 21. The friction state determination unit 133 determines a change amount regarding friction of the control target surface 21 on the basis of the control information. The friction state determination unit 133 determines a change amount regarding friction of the control target surface 21 on the basis of environment information of an environment in which the friction variable device 10 having the control target surface 21 is disposed. The friction state determination unit 133 determines a change amount regarding friction of the control target surface 21 on the basis of the user information of the user who uses the friction variable device 10 having the control target surface 21.

The actuator control unit 134 executes various types of processing. The actuator control unit 134 executes various types of information on the basis of the information from the external information processing apparatus and the information stored in the storage unit 120. The actuator control unit 134 executes various types of information on the basis of the information from another information processing apparatus such as the friction variable device 10.

The actuator control unit 134 executes various types of information on the basis of the various types of information acquired by the acquisition unit 131. The actuator control unit 134 executes various types of information on the basis of the various types of information determined by the input determination unit 132. The actuator control unit 134 executes various types of information on the basis of the various types of information determined by the friction state determination unit 133.

The actuator control unit 134 executes processing related to change of the friction state of the friction variable device 10. The actuator control unit 134 executes processing of changing the friction state of the friction variable device 10 to the friction state determined by the friction state determination unit 133. The actuator control unit 134 controls the friction state of the friction variable device 10 by instructing the friction variable device 10. The actuator control unit 134 instructs the friction variable device 10 to transmit information instructing a friction state to the friction variable device 10. The actuator control unit 134 executes processing of changing the friction state of the friction variable device 10 by controlling driving of a mechanism (actuator or the like) that causes the variable region (the first region 211 or the like) of the friction variable device 10 to advance or retract.

The actuator control unit 134 functions as a transmission unit that transmits various types of information to the external information processing apparatus. For example, the actuator control unit 134 transmits various types of information to another information processing apparatus such as the friction variable device 10.

The actuator control unit 134 provides various types of information on the basis of the information from another information processing apparatus such as the friction variable device 10. The actuator control unit 134 provides various types of information on the basis of the information stored in the storage unit 120. The actuator control unit 134 transmits the information stored in the storage unit 120.

The actuator control unit 134 transmits various types of information on the basis of the various types of information acquired by the acquisition unit 131. The actuator control unit 134 transmits various types of information on the basis of the various types of information determined by the input determination unit 132. The actuator control unit 134 transmits various types of information on the basis of the various types of information determined by the friction state determination unit 133. The actuator control unit 134 transmits various types of information to the friction variable device 10.

The actuator control unit 134 transmits instruction information instructing the friction variable device 10 to change the friction state to the friction variable device 10. The actuator control unit 134 transmits instruction information instructing the friction variable device 10 to change the friction state to the friction variable device 10. The actuator control unit 134 transmits control information for controlling the friction variable device 10 to the friction variable device 10 in accordance with an instruction from the actuator control unit 134. The actuator control unit 134 transmits, to the friction variable device 10, information instructing driving of the mechanism (actuator or the like) that causes the variable region (the first region 211 or the like) to advance or retract.

### 1-3. Procedure of Information Processing According to Embodiment

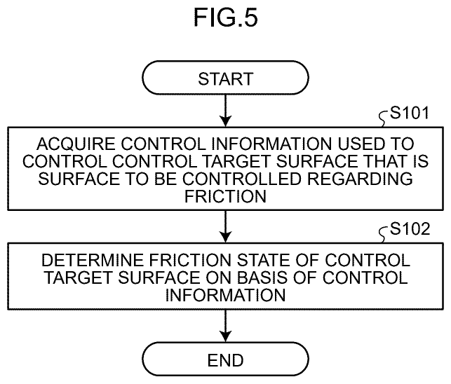

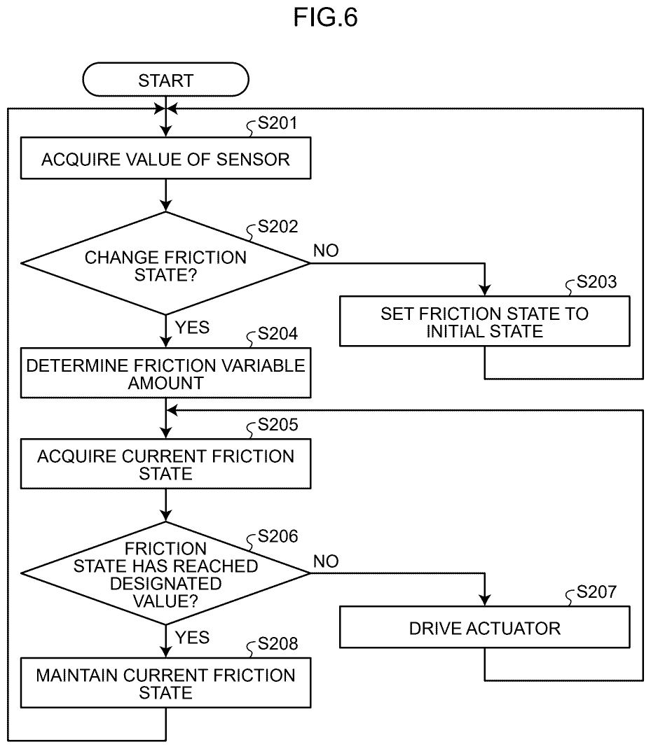

Hereinafter, a procedure of information processing according to the embodiment will be described with reference to FIGS. 5 to 6.

First, the procedure of information processing according to the embodiment will be described with reference to FIG. 5. FIG. 5 is a flowchart illustrating the procedure of information processing according to the embodiment of the present disclosure. Specifically, FIG. 5 is a flowchart illustrating a procedure of information processing by the information processing apparatus 100.

As illustrated in FIG. 5, the information processing apparatus 100 acquires control information used to control a control target surface that is a surface to be controlled regarding friction (step S101). For example, the information processing apparatus 100 acquires sensor information used for controlling the control target surface 21 detected by the sensing unit 12 as the control information.

The information processing apparatus 100 determines the friction state of the control target surface on the basis of the control information (step S102). For example, the information processing apparatus 100 determines to change the friction state of the control target surface 21 in a case where the status of the friction variable device 10 having the control target surface 21 satisfies the condition regarding the change of the friction state.

Next, a detailed example of processing in the friction control processing system 1 will be described with reference to FIG. 6. FIG. 6 is a flowchart illustrating a procedure of friction control processing of the friction control processing system.

As illustrated in FIG. 6, the friction control processing system 1 acquires a value of the sensor (step S201). For example, the information processing apparatus 100 acquires the value of the sensor detected by the sensing unit 12 from the friction variable device 10.

The friction control processing system 1 determines whether or not to change the friction state (step S202). For example, the information processing apparatus 100 determines whether or not to change the friction state of the control target surface 21 according to whether or not the status of the friction variable device 10 having the control target surface 21 satisfies the condition regarding the change of the friction state.

In a case where the friction state is not changed (step S202: No), the friction control processing system 1 sets the friction state to the initial state (step S203), and returns to step S201 to repeat the processing. For example, in a case where it is determined not to change the friction state, the information processing apparatus 100 instructs the friction variable device 10 to set the friction state to the initial state. Thus, the friction variable device 10 drives the actuator for advancing and retracting the variable region of the control target surface 21 in accordance with the instruction of the information processing apparatus 100 to advance or retract the variable region of the control target surface 21, and returns the control target surface 21 to the initial state.

In a case of changing the friction state (step S202: Yes), the friction control processing system 1 determines a friction variable amount (step S204). For example, in a case where it is determined to change the friction state, the information processing apparatus 100 determines a change amount regarding friction of the control target surface 21. Note that the information processing apparatus 100 may determine the change amount regarding the friction of the control target surface 21 by any information processing, but an example of a method of determining the friction variable amount will be described below.

The information processing apparatus 100 determines a change amount regarding friction of the control target surface on the basis of the control information. For example, the information processing apparatus 100 may determine the friction variable amount with two values of ON/OFF on the basis of a sensor value. In this case, the friction control processing system 1 sets any values in advance for the value corresponding to the ON state and the value corresponding to the OFF state. For example, the information processing apparatus 100 determines whether to set the friction state of the friction variable device 10 to ON (first state) or OFF (second state) on the basis of the sensor value.

In addition, the information processing apparatus 100 may determine the value using a function (also referred to as “friction determination function”) that defines the friction variable amount with respect to the acquired sensor value. For example, the information processing apparatus 100 may determine, with the sensor value as an input, the friction variable amount using a function (friction determination function) that outputs the friction variable amount corresponding to the input sensor value. In this case, the information processing apparatus 100 inputs the sensor value to the friction determination function, and uses the friction variable amount output by the friction determination function.

In addition, the information processing apparatus 100 may define a friction variable amount library for various parameters in advance, and determine the friction variable amount according to the status at that time. The friction variable amount library includes parameters (environmental parameters) corresponding to the environment such as temperature, humidity, weather, and air volume, parameters (skin parameters) corresponding to skin conditions such as water amount, oil content, and hair amount, and the like. Note that the friction variable amount library is not limited to the above, and includes a parameter related to a context (context parameter), a parameter related to a contact amount (contact parameter), a parameter corresponding to user information based on individual identification (user parameter), and the like.

For example, the information processing apparatus 100 may learn a model (friction amount estimation model) for estimating the friction amount necessary for the corresponding context and the user with information indicating the context, user information, and the like as inputs, and determine the friction variable amount using the friction amount estimation model. For example, the information processing apparatus 100 may determine the friction variable amount on the basis of the information output from the friction amount estimation model to which the information indicating the context, the user information, and the like are input. In this manner, the information processing apparatus 100 may determine the change amount regarding the friction of the control target surface 21 on the basis of the environment information of the environment in which the friction variable device 10 having the control target surface 21 is disposed. In addition, the information processing apparatus 100 may determine the change amount regarding the friction of the control target surface 21 on the basis of the user information of the user who uses the friction variable device 10 having the control target surface 21.

Then, the friction control processing system 1 acquires the current friction state (step S205). For example, the information processing apparatus 100 acquires information indicating the current friction state detected by the sensing unit 12 from the friction variable device 10.

Then, the friction control processing system 1 determines whether or not the friction state has reached a designated value (step S206). For example, the information processing apparatus 100 determines whether or not the current friction state detected by the sensing unit 12 has reached a designated value.

In a case where the current friction state does not reach the designated value (step S206: No), the friction control processing system 1 drives the actuator (step S207), and returns to step S205 to repeat the processing. For example, in a case where it is determined that the current friction state has not reached the designated value, the information processing apparatus 100 instructs the friction variable device 10 to drive an actuator for advancing and retracting the variable region of the control target surface 21. Thus, the friction variable device 10 drives the actuator in accordance with the instruction of the information processing apparatus 100 to advance and retreat the variable region of the control target surface 21 and change the shape of the control target surface 21 to a desired shape.

In a case where the current friction state has reached the designated value (step S206: Yes), the friction control processing system 1 maintains the current friction state (step S208), and returns to step S201 to repeat the processing. For example, in a case where it is determined that the current friction state has reached the designated value, the information processing apparatus 100 instructs the friction variable device 10 to hold the shape of the control target surface 21. Thus, the friction variable device 10 maintains the shape of the control target surface 21 in accordance with the instruction of the information processing apparatus 100.

### 1-4. Configuration Example of Support Member of Friction Variable Device

Here, an example of deformation of the support member 30 in a case where a force is applied to the support member 30 will be described with reference to FIGS. 7 and 8. FIGS. 7 and 8 are side views illustrating a support member of the friction variable device. FIG. 7 illustrates the support member 30 in a state where no force is applied to the support member 30, that is, before deformation. FIG. 8 illustrates the support member 30 in a state where a force is applied to the support member 30, that is, after deformation. FIGS. 7 and 8 illustrate a case where the contact target object is a cup and the curved side surface of the cup is a contact surface CS.

As illustrated in FIGS. 7 and 8, before the force is applied to the support member 30, the surface of the support member 30 has a planar shape not along the contact surface CS, and after the force is applied to the support member 30 in a direction approaching the contact surface CS, the surface of the support member 30 is deformed into a curved shape along the contact surface CS. As described above, when the force is applied in the direction approaching the contact surface CS, the support member 30 is deformed so as to follow the shape of the contact surface CS. As described above, in the friction variable device 10, in order to maximize the effect of friction, the sheet member 20 is bonded to the support member 30 capable of following the contact surface.

Note that, in FIGS. 7 and 8, a case where the support member 30 has a following structure such as a fin ray structure will be described as an example, but any structure can be adopted as long as the support member 30 can be deformed along the contact surface of the contact target object. For example, the support member 30 is not limited to the following structure, and various structures such as an auxetic structure and a bubble structure such as sponge can be adopted. Note that the auxetic structure may be a structure that follows a three-dimensional curved surface such as a structure that has a Poisson's ratio smaller than 0 and is deformable from a planar state to a dome shape. In addition, the bubble structure referred to herein may be any structure such as a closed cell structure or an open cell structure as long as it can be deformed along the contact surface of the contact target object.

### 1-5. Other Application Examples

Note that the friction variable device 10 is not limited to a glasses-type wearable device, and may be applied to any device. That is, the friction control processing system 1 described above is not limited to the control of the friction state of the glasses-type wearable device, and may be used for any purpose. Regarding this point, other application examples, effects thereof, and the like will be exemplified below. Note that, in the following description, description of points similar to the above-described contents will be appropriately omitted.

The friction control processing system 1 may be applied to a method of wearing a wearable device other than a glasses-type wearable device. In this case, the friction variable device 10 may be a neck type speaker or earphone, or a wristband type or leg band type device. The friction control processing system 1 may use sensing information as to whether or not the user is gripping as in the above-described processing for sensing attachment and detachment. For example, the friction control processing system 1 performs sensing regarding a motion state from vibration information of the device using an acceleration sensor.

Thus, the friction control processing system 1 can allow the user to more smoothly attach and detach the wearable device. For example, the neck hanging type device is larger than the neck and hence moves according to the user's motion state, and the wearability may be deteriorated. On the other hand, in the friction control processing system 1 described above, even when the user is in a motion state, the position can be fixed without depending on tightening, so that improvement in wearability can be expected.

The friction variable device 10 may be applied to a fingertip of a robot hand. The friction control processing system 1 may be applied to friction control of a robot hand fingertip. In this case, the friction control processing system 1 may use the sensing information as to whether or not the user is gripping, similarly to the above-described processing. The friction control processing system 1 may sense not only the holding timing but also the type of the object by camera sensing or the like.

Thus, the friction control processing system 1 can easily grip even with weak force by changing the friction of the fingertip. Further, in a case where the friction variable device 10 is used for the fingertip of the communication robot, the friction control processing system 1 can also perform an interaction of gradually reducing the frictional force in accordance with the gripping state of the person, instead of a binary operation of gripping or separating when performing the operation of transferring an object to the person.

The friction variable device 10 may be used on a back surface of a smartphone. The friction control processing system 1 may be applied to friction control of a back surface of a smartphone. In this case, the friction control processing system 1 performs touch sensing using a graphical user interface (GUI) or sensing using a physical button. In addition, the friction control processing system 1 may perform sensing using gesture recognition using pressure or the like.

Thus, in the friction control processing system 1, when the user performs an operation such as gripping the smartphone with one hand, placing the smartphone on a desk, leaning the smartphone against a wall, or crouching while placing the smartphone in a pocket, the back surface of the smartphone becomes highly frictional and can be made less slippery. On the other hand, in the friction control processing system 1, when the user puts the smartphone in the pocket, the friction becomes low, and the user can smoothly take the smartphone. As described above, the friction control processing system 1 can implement the optimum friction state according to the context of the user.

The friction variable device 10 may be used for furniture such as a chair, a desk, and a shelf. The friction control processing system 1 may control the friction between the control target surface and the floor surface using surfaces of soles of furniture such as a chair, a desk, or a shelf as the control target surface.

In this case, the friction control processing system 1 performs touch sensing using a GUI and sensing using a physical button. In addition, the friction control processing system 1 may perform sensing using gesture recognition using pressure or the like.

As described above, the friction control processing system 1 enables intuitive operation of the physical object without using a lock mechanism or the like by controlling the friction in accordance with a status such as movement or fixing of the furniture. Further, in a case where a plurality of pieces of furniture is aligned in a classroom, a conference room, or the like, the friction control processing system 1 can cooperate with digital information such as braking when the furniture is brought to an arbitrary position.

The friction variable device 10 may be used for cardboard or a packaging case. The friction control processing system 1 may use a side surface of a gripping target object such as cardboard or a packing case as a control target surface, and control friction of the control target surface. In this case, the friction control processing system 1 may use the sensing information as to whether or not the user is gripping, similarly to the above-described processing.

As described above, the friction control processing system 1 can facilitate gripping by increasing friction when a person or a robot grips a cardboard or a packaging case. On the other hand, the friction control processing system 1 has low friction and can easily move when sliding a floor or packing a cardboard, a packing case, or the like on a platform or a shelf.

The friction variable device 10 may be used for rolling items such as an arm roll of clothing and a cord. The friction control processing system 1 may control friction of a product to be used by rolling or deploying. In this case, the friction control processing system 1 performs touch sensing using a GUI and sensing using a physical button. Thus, the friction control processing system 1 can simplify operations such as low friction at the time of deployment (when not rolling) but high friction at the time of rolling to improve cohesion.

### 2. Other Embodiments

The processing according to each embodiment described above may be performed in various different forms (modifications) other than each embodiment described above. Hereinafter, modifications and the like will be described.

### 2-1. Other Configuration Examples

In the above-described friction control processing system 1, the configuration example in which the friction variable device 10 includes the sensing unit 12 has been described, but the above-described configuration is an example, and any device configuration can be adopted as the friction control processing system as long as the sensing information can be used to change the friction state of the friction variable device 10. Regarding this point, a first modification and a second modification will be described as other configuration examples.

### 2-1-1. First Modification

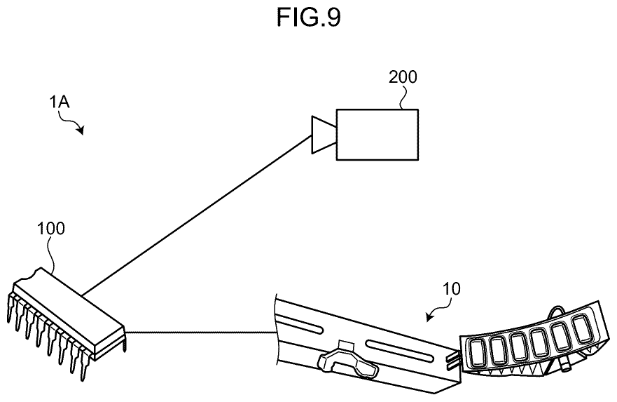

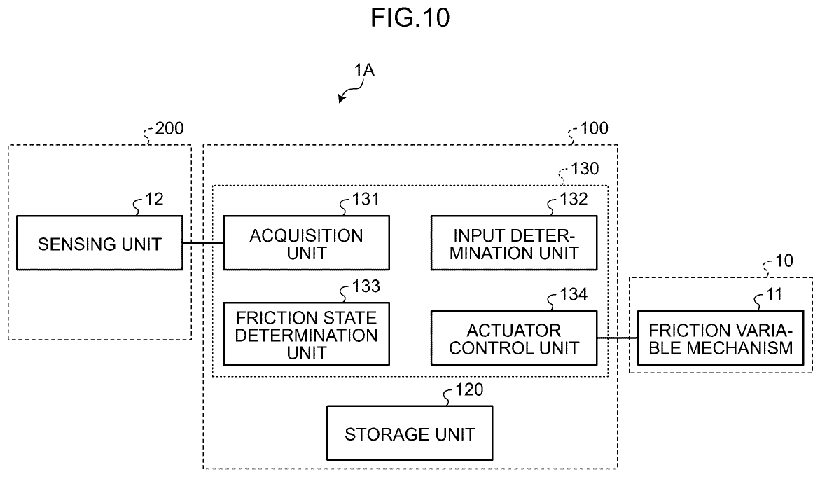

First, a friction control processing system 1A according to a first modification will be described with reference to FIGS. 9 and 10. FIG. 9 is a view illustrating a configuration example of the friction control processing system according to the first modification of the present disclosure. FIG. 10 is a diagram illustrating a functional configuration example of the friction control processing system according to the first modification of the present disclosure. Note that description of points similar to those in the embodiment will be omitted as appropriate.

As illustrated in the friction control processing system 1A of FIGS. 9 and 10, the friction variable device 10 and the sensing device may be separate, and the sensing unit 12 may be included in a sensor device 200 that is a separate device from the friction variable device 10. Note that the illustration of the sensor device 200 illustrated in FIG. 9 is for illustrating an image, and any configuration can be adopted as the configuration of the sensor device 200 as long as desired information can be acquired, and the configuration is not limited to the configuration corresponding to the illustration.

As illustrated in FIG. 9, the friction control processing system 1A includes the information processing apparatus 100, the friction variable device 10, and the sensor device 200. Note that the friction control processing system 1 may include a plurality of information processing apparatuses 100, a plurality of friction variable devices 10, and a plurality of sensor devices 200.

As illustrated in FIG. 10, in the friction control processing system 1A, the sensor device 200 includes the sensing unit 12. In the friction control processing system 1A, the information processing apparatus 100 acquires sensing information from the sensor device 200. For example, in the friction control processing system 1A, the information processing apparatus 100 is communicably connected to the sensor device 200 by wired or near field communication. The sensor device 200 may have any arrangement mode as long as it can transmit and receive information to and from the information processing apparatus 100. For example, the sensor device 200 may be disposed at a position separated from the information processing apparatus 100 and the friction variable device 10. For example, the sensor device 200 may be disposed by being attached to the friction variable device 10. For example, the sensor device 200 may be provided in the friction variable device 10. In FIG. 2, the sensor device 200 may be provided on the front unit 40 of the friction variable device 10, or may be provided on the sheet member 20 or the support member 30.

Note that the functional configuration of the friction control processing system 1A illustrated in FIG. 10 is merely an example, and the friction control processing system 1A may have any functional configuration. For example, in the friction control processing system 1A illustrated in FIG. 10, a case where the friction variable device 10 does not include the sensing unit 12 is illustrated, but in a case where pressure or the like is detected in order to determine grip or the like of the friction variable device 10 by the user, the friction variable device 10 may include the sensing unit 12.

### 2-1-2. Second Modification

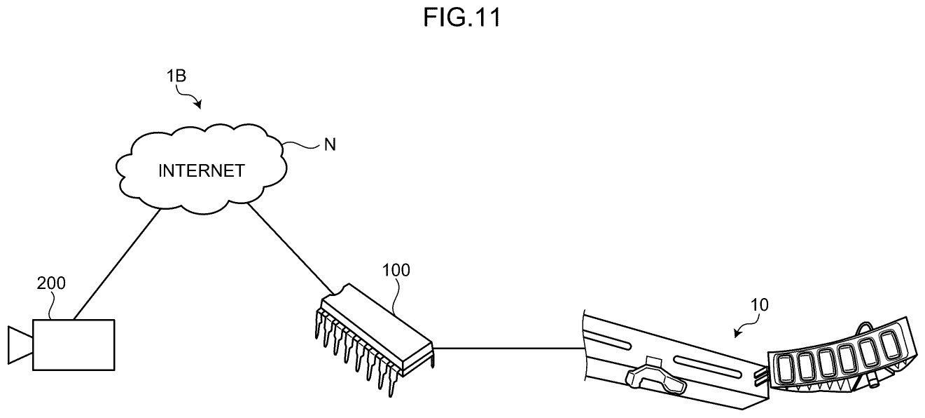

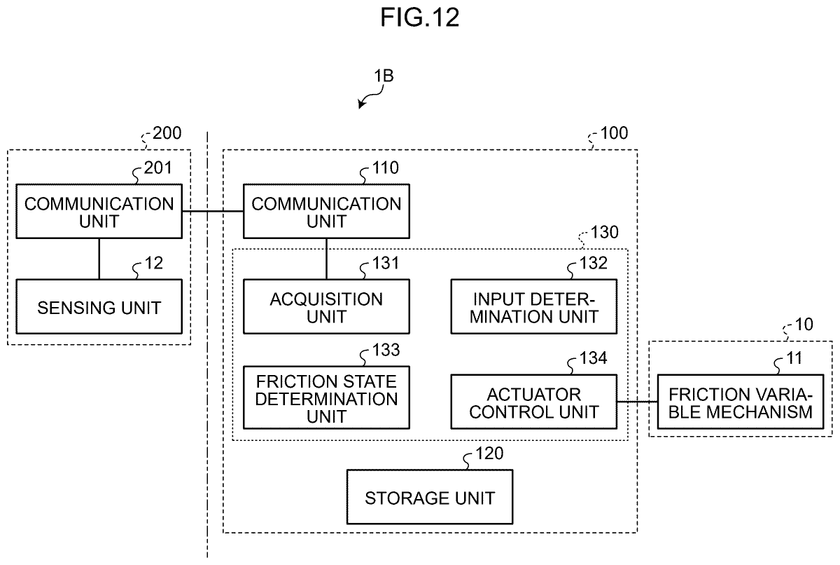

Next, a friction control processing system 1B according to a second modification will be described with reference to FIGS. 11 and 12. FIG. 11 is a view illustrating a configuration example of the friction control processing system according to the second modification of the present disclosure. FIG. 12 is a diagram illustrating a functional configuration example of the friction control processing system according to the second modification of the present disclosure. Note that description of the same points as in the embodiment and the first modification will be omitted as appropriate.

As illustrated in the friction control processing system 1B of FIGS. 11 and 12, the information processing apparatus 100 and the sensor device 200 may communicate via a network N. In this case, as illustrated in FIG. 11, in the friction control processing system 1B, the information processing apparatus 100 is communicably connected to the sensor device 200 via the network N.

As illustrated in FIG. 12, in the friction control processing system 1B, the information processing apparatus 100 includes a communication unit 110, a storage unit 120, and a control unit 130. The communication unit 110 is implemented by, for example, a network interface card (NIC) or the like. Then, the communication unit 110 is connected to the network N in a wired or wireless manner, and transmits and receives information to and from another information processing apparatus such as the sensor device 200. Note that the communication unit 110 may communicate with the friction variable device 10 to transmit and receive information to and from the friction variable device 10.

Further, as illustrated in FIG. 12, in the friction control processing system 1B, the sensor device 200 includes the sensing unit 12 and a communication unit 201. The communication unit 201 is implemented by, for example, an NIC or the like. Then, the communication unit 201 is connected to the network N in a wired or wireless manner, and transmits and receives information to and from another information processing apparatus such as the information processing apparatus 100. Note that the communication unit 201 may communicate with the friction variable device 10 to transmit and receive information to and from the friction variable device 10.

In the friction control processing system 1B, the information processing apparatus 100 acquires sensing information from the sensor device 200 via the network N. For example, in the friction control processing system 1B, the information processing apparatus 100 is communicably connected to the sensor device 200 by any network N such as the Internet.

Note that the functional configuration of the friction control processing system 1B illustrated in FIG. 12 is merely an example, and the friction control processing system 1B may have any functional configuration. For example, in the friction control processing system 1B illustrated in FIG. 12, a case where the friction variable device 10 does not include the sensing unit 12 is illustrated, but in a case where pressure or the like is detected in order to determine grip or the like of the friction variable device 10 by the user, the friction variable device 10 may include the sensing unit 12.

### 2-2. Others

Further, among the processes described in the above embodiments, all or part of the processes described as being performed automatically can be performed manually, or all or part of the processes described as being performed manually can be performed automatically by a publicly known method. Further, the processing procedure, specific name, and information including various data and parameters illustrated in the above document and the drawings can be arbitrarily changed unless otherwise specified. For example, the various types of information depicted in each figure are not limited to the depicted information.

Further, each component of each device depicted in the drawings is functionally conceptual, and is not necessarily physically configured as depicted in the drawings. That is, a specific form of distribution and integration of each device is not limited to the depicted form, and all or a part thereof can be functionally or physically distributed and integrated in any unit according to various loads, usage status, and the like.

Further, the above-described embodiments and modification examples can be appropriately combined within a range not contradicting processing contents.

In addition, the effects described in the present description are merely examples and are not limited, and other effects may be provided.

### 3. Effects According to Present Disclosure

As described above, the information processing apparatus (the information processing apparatus 100 in the embodiment) according to the present disclosure includes the acquisition unit (the acquisition unit 131 in the embodiment) and the friction state determination unit (the friction state determination unit 133 in the embodiment). The acquisition unit acquires control information used to control a control target surface that is a surface to be controlled regarding friction. The friction state determination unit determines the friction state of the control target surface on the basis of the control information acquired by the acquisition unit.

As described above, the information processing apparatus according to the present disclosure determines the friction state of the control target surface on the basis of the control information used to control the control target surface that is a surface to be controlled regarding friction, and thus can change the friction state of the surface to be controlled using any information. Therefore, the information processing apparatus can appropriately change the friction state of the surface to be controlled.

Further, the acquisition unit acquires sensor information detected by the sensor as control information. The friction state determination unit determines the friction state of the control target surface on the basis of the sensor information. In this manner, the information processing apparatus can change the friction state of the surface to be controlled without an explicit instruction of the user by determining the friction state of the control target surface on the basis of the sensor information detected by the sensor. Therefore, the information processing apparatus can appropriately change the friction state of the surface to be controlled.

Further, the friction state determination unit determines whether or not to change the friction state of the control target surface on the basis of the control information. In this manner, the information processing apparatus determines whether or not to change the friction state of the control target surface on the basis of the control information, thereby being able to change the friction state of the surface to be controlled using any information. Therefore, the information processing apparatus can appropriately change the friction state of the surface to be controlled.

Further, the friction state determination unit determines whether or not to change the friction state of the control target surface according to a status of a friction variable device having the control target surface based on the control information. In this manner, the information processing apparatus can change the friction state of the surface of the friction variable device by determining whether or not to change the friction state of the control target surface according to the status of the friction variable device having the control target surface. Therefore, the information processing apparatus can appropriately change the friction state of the surface to be controlled.

Further, the friction state determination unit determines to change the friction state of the control target surface in a case where the status of the friction variable device having the control target surface satisfies a condition regarding a change of the friction state. As described above, the information processing apparatus can change the friction state of the surface of the friction variable device by determining to change the friction state of the control target surface in a case where the status of the friction variable device having the control target surface satisfies the condition regarding the change of the friction state. Therefore, the information processing apparatus can appropriately change the friction state of the surface to be controlled.

Further, the friction state determination unit determines a change amount regarding friction of the control target surface. In this manner, the information processing apparatus can appropriately determine the change amount regarding the friction of the control target surface by determining the change amount regarding the friction of the control target surface. Therefore, the information processing apparatus can appropriately change the friction state of the surface to be controlled.

Further, the friction state determination unit determines a change amount regarding friction of the control target surface on the basis of the control information. In this manner, the information processing apparatus can appropriately determine the change amount regarding the friction of the control target surface according to the control content by determining the change amount regarding the friction of the control target surface on the basis of the control information. Therefore, the information processing apparatus can appropriately change the friction state of the surface to be controlled.

Further, the friction state determination unit determines a change amount regarding friction of the control target surface on the basis of environment information of an environment in which a friction variable device having the control target surface is disposed. As described above, the information processing apparatus determines the change amount regarding the friction of the control target surface on the basis of the environment information of the environment in which the friction variable device having the control target surface is disposed, whereby the amount of change related to the friction of the control target surface can be appropriately determined according to the environment. Therefore, the information processing apparatus can appropriately change the friction state of the surface to be controlled.

Further, the friction state determination unit determines the change amount regarding the friction of the control target surface on the basis of user information of a user who uses a friction variable device having the control target surface. As described above, the information processing apparatus determines the change amount regarding the friction of the control target surface on the basis of the user information of the user who uses the friction variable device having the control target surface, whereby the change amount regarding the friction of the control target surface can be appropriately determined according to the user who uses the friction variable device. Therefore, the information processing apparatus can appropriately change the friction state of the surface to be controlled.

As described above, the friction variable device (the friction variable device 10 in the embodiment) according to the present disclosure includes a control target surface (the control target surface 21 in the embodiment) that is provided with a first member having a first friction coefficient and a second member having a second friction coefficient that is a friction coefficient different from the first friction coefficient, the control target surface being a surface having a changeable shape, and a friction variable mechanism (the friction variable mechanism 11 in the embodiment) capable of changing a frictional force of the control target surface by changing the shape of the control target surface.

As described above, in the friction variable device according to the present disclosure, by providing two members of the first member and the second member having different friction states on the surface whose shape can be changed, the friction state can be changed by changing the shape. Therefore, the information processing apparatus can appropriately change the friction state of the surface to be controlled.

Further, the control target surface is a surface that comes into contact with a contact target object (the user U1 in the embodiment), and the friction variable mechanism controls the frictional force of the control target surface by changing the shape of the control target surface and changing a contact mode between the control target surface and the contact target object. As described above, the friction variable device can change the friction state by changing the shape of the surface in contact with the contact target object. Therefore, the information processing apparatus can appropriately change the friction state of the surface to be controlled.

Further, the control target surface includes the first member having the first friction coefficient and the second member having the second friction coefficient higher than the first friction coefficient. As described above, the friction variable device can change the friction state by changing the shape of the surface on which the first member having the first friction coefficient and the second member having the second friction coefficient higher than the first friction coefficient are provided. Therefore, the information processing apparatus can appropriately change the friction state of the surface to be controlled.

Further, in the control target surface, the first member and the second member are alternately provided in a direction along the control target surface. As described above, the friction variable device can change the friction state by changing the shape of the surface in which the first member and the second member are alternately provided in the direction along the control target surface. Therefore, the information processing apparatus can appropriately change the friction state of the surface to be controlled.

Further, the control target surface has a variable region (the first region 211 in the embodiment) capable of advancing and retracting in a direction intersecting the control target surface by control of the friction variable mechanism, one of the first member or the second member is provided in the variable region, and the other different from the one is provided in a region other than the variable region (the second region 212 in the embodiment), and the friction variable mechanism controls the frictional force of the control target surface by advancing and retracting the variable region. As described above, the friction variable device can change the friction state by changing the shape of the surface on which one member of the first member or the second member is provided in the variable region capable of advancing and retracting in the direction intersecting the control target surface. Therefore, the information processing apparatus can appropriately change the friction state of the surface to be controlled.

Further, the control target surface includes the first member provided in the variable region, and the friction variable mechanism controls the frictional force of the control target surface by advancing and retracting the variable region provided with the first member. As described above, the friction variable device can change the friction state by changing the shape of the surface on which the first member is provided in the variable region. Therefore, the information processing apparatus can appropriately change the friction state of the surface to be controlled.

Further, the friction variable device includes a support member (the support member 30 in the embodiment) that is provided on a back surface (the back surface 24 in the embodiment) side of the control target surface and supports the control target surface. As described above, in the friction variable device, the control target surface is supported by the support member from the back surface side of the control target surface, whereby a surface whose shape changes can be appropriately supported. Therefore, the information processing apparatus can appropriately change the friction state of the surface to be controlled.

Further, the support member deforms along a contact surface of a contact target object (the skin surface of the head HD in the embodiment). As described above, in the friction variable device, the support member is deformed so that the control target surface follows the contact surface of the contact target object, whereby the surface whose shape changes can be deformed in accordance with the contact surface of the contact target object. Therefore, the information processing apparatus can appropriately change the friction state of the surface to be controlled.

Further, the support member has a structure that follows the contact surface. For example, the support member has at least one of a following structure such as a Fin Ray structure, an auxetic structure, or a bubble structure. As described above, in the friction variable device, by using the support member having a structure suitable for changing the shape, the surface whose shape changes can be deformed in accordance with the contact surface of the contact target object. Therefore, the information processing apparatus can appropriately change the friction state of the surface to be controlled.

Further, the friction variable device is a wearable device worn by the user. In this manner, the friction variable device can be used as a wearable device worn by the user.

### 4. Hardware Configuration

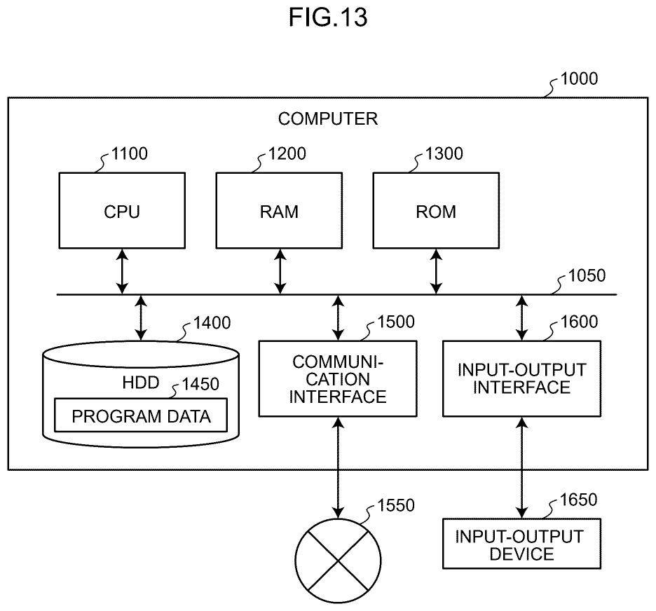

The information apparatus such as the information processing apparatus 100 according to each of the above-described embodiments and modification examples is implemented by, for example, a computer 1000 having a configuration as illustrated in FIG. 13. FIG. 13 is a hardware configuration diagram illustrating an example of the computer 1000 that implements functions of an information processing apparatus such as the information processing apparatus 100. Hereinafter, the information processing apparatus 100 according to the embodiment will be described as an example. The computer 1000 includes a CPU 1100, a RAM 1200, a read only memory (ROM) 1300, a hard disk drive (HDD) 1400, a communication interface 1500, and an input-output interface 1600. Each section of the computer 1000 is connected by a bus 1050.

The CPU 1100 operates on the basis of a program stored in the ROM 1300 or the HDD 1400, and controls each section. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by such a program, and the like. Specifically, the HDD 1400 is a recording medium that records an information processing program according to the present disclosure as an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input-output interface 1600 is an interface for connecting an input-output device 1650 and the computer 1000. For example, the CPU 1100 receives data from an input device such as a keyboard and a mouse via the input output interface 1600. Further, the CPU 1100 transmits data to an output device such as a display, a speaker, or a printer via the input-output interface 1600. In addition, the input-output interface 1600 may function as a media interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 100 according to the embodiment, the CPU 1100 of the computer 1000 implements the functions of the control unit 130 and the like by executing the information processing program loaded on the RAM 1200. In addition, the HDD 1400 stores an information processing program according to the present disclosure and data in the storage unit 120. Note that the CPU 1100 reads the program data 1450 from the HDD 1400 and executes the program data 1450, but as another example, these programs may be acquired from another device via the external network 1550.

Note that the present technology can also have the following configurations.
(1)

An information processing apparatus comprising:
an acquisition unit that acquires control information used to control a control target surface that is a surface to be controlled regarding friction; and
a friction state determination unit that determines a friction state of the control target surface on a basis of the control information acquired by the acquisition unit.
(2)

The information processing apparatus according to (1), wherein
the acquisition unit
acquires sensor information detected by a sensor as the control information, and
the friction state determination unit
determines the friction state of the control target surface on a basis of the sensor information.
(3)

The information processing apparatus according to (1) or (2), wherein
the friction state determination unit
determines whether or not to change the friction state of the control target surface on a basis of the control information.
(4)

The information processing apparatus according to any one of (1) to (3), wherein
the friction state determination unit
determines whether or not to change the friction state of the control target surface according to a status of a friction variable device having the control target surface based on the control information.
(5)

The information processing apparatus according to (4), wherein
the friction state determination unit
determines to change the friction state of the control target surface in a case where the status of the friction variable device having the control target surface satisfies a condition regarding a change of the friction state.
(6)

The information processing apparatus according to any one of (1) to (5), wherein
the friction state determination unit
determines a change amount regarding friction of the control target surface.
(7)

The information processing apparatus according to (6), wherein
the friction state determination unit
determines the change amount regarding the friction of the control target surface on a basis of the control information.
(8)

The information processing apparatus according to (6) or (7), wherein
the friction state determination unit
determines the change amount regarding the friction of the control target surface on a basis of environment information of an environment in which a friction variable device having the control target surface is disposed.
(9)

The information processing apparatus according to any one of (6) to (8), wherein
the friction state determination unit
determines the change amount regarding the friction of the control target surface on a basis of user information of a user who uses a friction variable device having the control target surface.
(10)

An information processing method comprising:
acquiring control information used to control a control target surface that is a surface to be controlled regarding friction; and
determining a friction state of the control target surface on a basis of the acquired control information.
(11)

A friction variable device comprising:
a control target surface that is provided with a first member having a first friction coefficient and a second member having a second friction coefficient that is a friction coefficient different from the first friction coefficient, the control target surface being a surface having a changeable shape; and
a friction variable mechanism capable of changing a frictional force of the control target surface by changing the shape of the control target surface.
(12)

The friction variable device according to (11), wherein
the control target surface is
a surface that comes into contact with a contact target object, and
the friction variable mechanism
controls the frictional force of the control target surface by changing the shape of the control target surface and changing a contact mode between the control target surface and the contact target object.
(13)

The friction variable device according to (11) or (12), wherein
the control target surface includes
the first member and the second member having the second friction coefficient higher than the first friction coefficient.
(14)

The friction variable device according to any one of (11) to (13), wherein
the control target surface includes
the first member and the second member alternately provided in a direction along the control target surface.
(15)

The friction variable device according to any one of (11) to (14), wherein
the control target surface has
a variable region capable of advancing and retracting in a direction intersecting the control target surface by control of the friction variable mechanism, one of the first member or the second member is provided in the variable region, and another different from the one is provided in a region other than the variable region, and
the friction variable mechanism
controls the frictional force of the control target surface by advancing and retracting the variable region.
(16)

The friction variable device according to (15), wherein
the control target surface includes
the first member provided in the variable region, and
the friction variable mechanism
controls the frictional force of the control target surface by advancing and retracting the variable region provided with the first member.
(17)

The friction variable device according to any one of (11) to (16), comprising:
a support member that is provided on a back surface side of the control target surface and supports the control target surface.
(18)

The friction variable device according to (17), wherein
the support member
deforms along a contact surface of a contact target object.
(19)

The friction variable device according to (18), wherein
the support member has
at least one of a following structure, an auxetic structure, or a bubble structure.
(20)

The friction variable device according to any one of (11) to (19), wherein
the friction variable device is a wearable device worn by a user.

### REFERENCE SIGNS LIST

1 FRICTION CONTROL PROCESSING SYSTEM
100 INFORMATION PROCESSING APPARATUS
110 COMMUNICATION UNIT
120 STORAGE UNIT
130 CONTROL UNIT
131 ACQUISITION UNIT
132 INPUT DETERMINATION UNIT
133 FRICTION STATE DETERMINATION UNIT
134 ACTUATOR CONTROL UNIT
10 FRICTION VARIABLE DEVICE
11 FRICTION VARIABLE MECHANISM
12 SENSING UNIT
20 SHEET MEMBER
21 CONTROL TARGET SURFACE
211 FIRST REGION
212 SECOND REGION
22 FIRST MEMBER
23 SECOND MEMBER
24 BACK SURFACE
30 SUPPORT MEMBER

1. An information processing apparatus comprising:
an acquisition unit that acquires control information used to control a control target surface that is a surface to be controlled regarding friction; and
a friction state determination unit that determines a friction state of the control target surface on a basis of the control information acquired by the acquisition unit.

2. The information processing apparatus according to claim 1, wherein
the acquisition unit
acquires sensor information detected by a sensor as the control information, and
the friction state determination unit
determines the friction state of the control target surface on a basis of the sensor information.

3. The information processing apparatus according to claim 1, wherein
the friction state determination unit
determines whether or not to change the friction state of the control target surface on a basis of the control information.

4. The information processing apparatus according to claim 1, wherein
the friction state determination unit
determines whether or not to change the friction state of the control target surface according to a status of a friction variable device having the control target surface based on the control information.

5. The information processing apparatus according to claim 4, wherein
the friction state determination unit
determines to change the friction state of the control target surface in a case where the status of the friction variable device having the control target surface satisfies a condition regarding a change of the friction state.

6. The information processing apparatus according to claim 1, wherein
the friction state determination unit
determines a change amount regarding friction of the control target surface.

7. The information processing apparatus according to claim 6, wherein
the friction state determination unit
determines the change amount regarding the friction of the control target surface on a basis of the control information.

8. The information processing apparatus according to claim 6, wherein
the friction state determination unit
determines the change amount regarding the friction of the control target surface on a basis of environment information of an environment in which a friction variable device having the control target surface is disposed.

9. The information processing apparatus according to claim 6, wherein
the friction state determination unit
determines the change amount regarding the friction of the control target surface on a basis of user information of a user who uses a friction variable device having the control target surface.

10. An information processing method comprising:
acquiring control information used to control a control target surface that is a surface to be controlled regarding friction; and
determining a friction state of the control target surface on a basis of the acquired control information.

11. A friction variable device comprising:
a control target surface that is provided with a first member having a first friction coefficient and a second member having a second friction coefficient that is a friction coefficient different from the first friction coefficient, the control target surface being a surface having a changeable shape; and
a friction variable mechanism capable of changing a frictional force of the control target surface by changing the shape of the control target surface.

12. The friction variable device according to claim 11, wherein
the control target surface is
a surface that comes into contact with a contact target object, and
the friction variable mechanism
controls the frictional force of the control target surface by changing the shape of the control target surface and changing a contact mode between the control target surface and the contact target object.

13. The friction variable device according to claim 11, wherein
the control target surface includes
the first member and the second member having the second friction coefficient higher than the first friction coefficient.

14. The friction variable device according to claim 11, wherein
the control target surface includes
the first member and the second member alternately provided in a direction along the control target surface.

15. The friction variable device according to claim 11, wherein
the control target surface has
a variable region capable of advancing and retracting in a direction intersecting the control target surface by control of the friction variable mechanism, one of the first member or the second member is provided in the variable region, and another different from the one is provided in a region other than the variable region, and
the friction variable mechanism
controls the frictional force of the control target surface by advancing and retracting the variable region.

16. The friction variable device according to claim 15, wherein
the control target surface includes
the first member provided in the variable region, and
the friction variable mechanism
controls the frictional force of the control target surface by advancing and retracting the variable region provided with the first member.

17. The friction variable device according to claim 11, comprising:
a support member that is provided on a back surface side of the control target surface and supports the control target surface.

18. The friction variable device according to claim 17, wherein
the support member
deforms along a contact surface of a contact target object.

19. The friction variable device according to claim 18, wherein
the support member has
at least one of a following structure, an auxetic structure, or a bubble structure.

20. The friction variable device according to claim 11, wherein
the friction variable device is a wearable device worn by a user.
